(19) United States
(12) Patent Application Publication
(10) Pub. No.: US 2011/0050590 A1
(43) Pub. Date: Mar. 3, 2011

(54) Touch Screen Cookbook

(76) Inventor: John Anthony Viglione, New York, NY (US)

(21) Appl. No.: 12/552,428

(22) Filed: Sep. 2, 2009

(51) Int. Cl. G06F 3/041; G06F 1/16

(52) U.S. Cl. 345/173; 361/679.26; 704/275

(57) ABSTRACT

An electronic portable device which may used to enter, display, store, and/or retrieve culinary recipes with ease such as through touch screen capabilities and that may be implemented in a completely portable mode.

### FIELD OF THE INVENTION

The present invention relates to graphical user interfaces, and more particularly to graphical user interfaces that are particularly useful for providing access to food related items.

### BACKGROUND OF THE INVENTION

Communications in one form or another have long played a part in the day-to-day home life of individuals and families. These communications might simply be messages to oneself, such as recipes or they may be intended to communicate information from one person to another (or others), either within the same household or to someone outside the house.

Various types of communication devices have been made available for the purpose of making the intended communication easier, faster and/or more efficient. Fax machines and personal computers (PCs) are examples of such devices. By and large, however, these devices are designed for use in office-like settings. Thus, for example, a PC usually requires enough desk space to hold a keyboard and monitor, and possibly also a base unit that houses the computer motherboard.

It is possible to incorporate some of the office-oriented equipment into the home for use there as well. Often this involves setting up an area of the home that becomes a “home office” space (either a separate room, or a portion of a room) that is used for home office-related activities. Consequently, to make use of this home equipment, one must make an effort to go to the home office space.

Lifestyles typically do not center around the home office space, however. One consequence of this is that one might at times feel disinclined to make use of the equipment because it feels like too much of an effort. Thus, for example, one might put off entering recipes into a computerized recipe organizer.

One could attempt to solve this problem by moving the communications equipment into a location that would make it more readily accessible to family members in their normal day-to-day lives. However, such a solution is problematic for several reasons. First, as mentioned above, conventional equipment often requires more space (e.g., table space and the like) than most family rooms can accommodate without at least compromising the decor of the room. Moreover, many household occupants do not feel comfortable with, or are otherwise intimidated by conventional equipment such as PCs, which can often require knowledge of how to boot up a system, how to select and launch programs, and how to gracefully shut down a system. Put another way, the operating systems of conventional systems provide a user interface that is out of place in a home setting. Rather than interacting with the equipment in a way that feels natural, the user instead has to perform actions associated with a desktop metaphor.

Although other devices certainly exist in an attempt to solve this problem, the main difference between this device and the other application is portability, as opposed to a mounted monitor.

It does have the option of being mounted, but because it's also portable it can easily be positioned and moved anywhere in the kitchen, while still standing upright. Often editing, sharing, and uploading recipes can be time consuming and the user may not be comfortable standing in kitchen while doing this. This device can be easily be brought from the kitchen to a home computer, or sofa so the user is more comfortable while managing recipes. Another advantage is that its portability allows one to take it on vacation, to the supermarket, or lend to others to use/borrow.

The voice activation feature also differentiates it from other devices. Your hands often get messy while cooking so this may be easier, and cleaner than touching the screen.

This device is also waterproof so it won't get damaged since cooking areas often get messy.

There is therefore a need to provide information storage methods and apparatuses that are suitable for use in a home setting, and which more naturally fit into existing home life behaviors as carried out within the kitchen.

### SUMMARY OF THE INVENTION

Approximately 4″×6″ Touch screen Monitor. Support on back so it stands up straight on a kitchen counter, and mounting device on back to fasten to the bottom of a cabinet

It consolidates and organizes all of your recipes on to one small device replacing the need for multiple cookbooks, or having to print out recipes from the internet.

This invention is an electronic touch screen cookbook, which can hold all of the owner's recipes within its database. It would be sold with a library of recipes programmed into the device. Any additional recipes can be downloaded via Wi-Fi internet connection or by connecting it to a home computer via USB or Fire wire port. New recipes can also be entered manually.

### BRIEF DESCRIPTION OF THE DRAWINGS

FIG. 1 depicts the front and right side perspective view.

FIG. 2 depicts the top and right side perspective view.

FIG. 3 depicts the back to top side perspective view with the folding stand.

FIG. 4 depicts the front touch screen.

FIG. 5 depicts the front perspective view of the device.

FIG. 6 depicts the device while mounted under a cabinet.

Other objects, features and advantages of the present invention will become apparent from the detailed description of the invention which follows, when considered in light of the accompanying drawings which:

### DETAILED DESCRIPTION OF THE PREFERRED EMBODIMENTS

1. Power Button
2. Touch Screen
3. Charger Socket
4. Microphone Receiver
5. Rubber Guard for USB & Fire Wire Ports
6. Rubber Guard for Charging Port
7. USB Port
8. Fire wire Port
9. Charging Port
10. Connection socket for cabinet mounting
11. Fold out stand
12. Hand held view
13. Fold out stand on counter
14. Jointed cabinet connecting arm
15. Folds away under cabinet

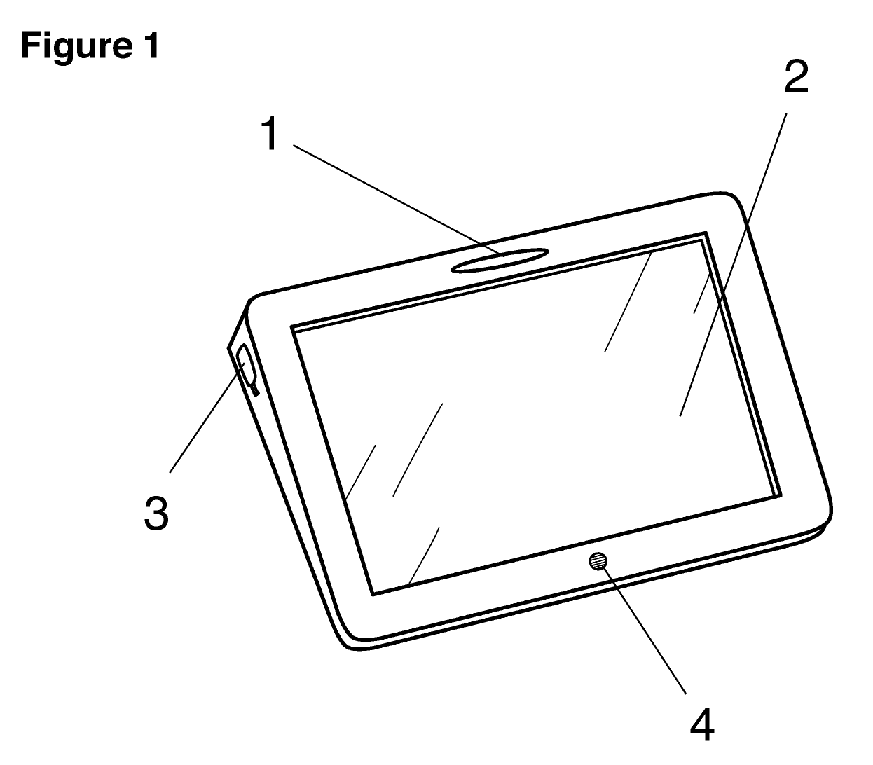

FIG. 1 shows the front view of the device which features the main touch screen (2), the power button (1), the Microphone Receiver (4) ,and the charger socket (3). The main touch screen (2) is where all information and program features stored inside the device are made visible to the user. The main touch screen (2) is the surface in which the user will touch in order to interact with the device. Each time the user wishes to use the device the power button will be pressed (1) to activate and deactivate the device before and after each use. The Touchscreen Cookbook has a microphone receiver (4) which is used to receive voice commands when not accessing information using the touch screen (2). The charger socket (3) holds the charging cable which extends from the charger socket (3) to a wall outlet. This will charge the battery of the device.

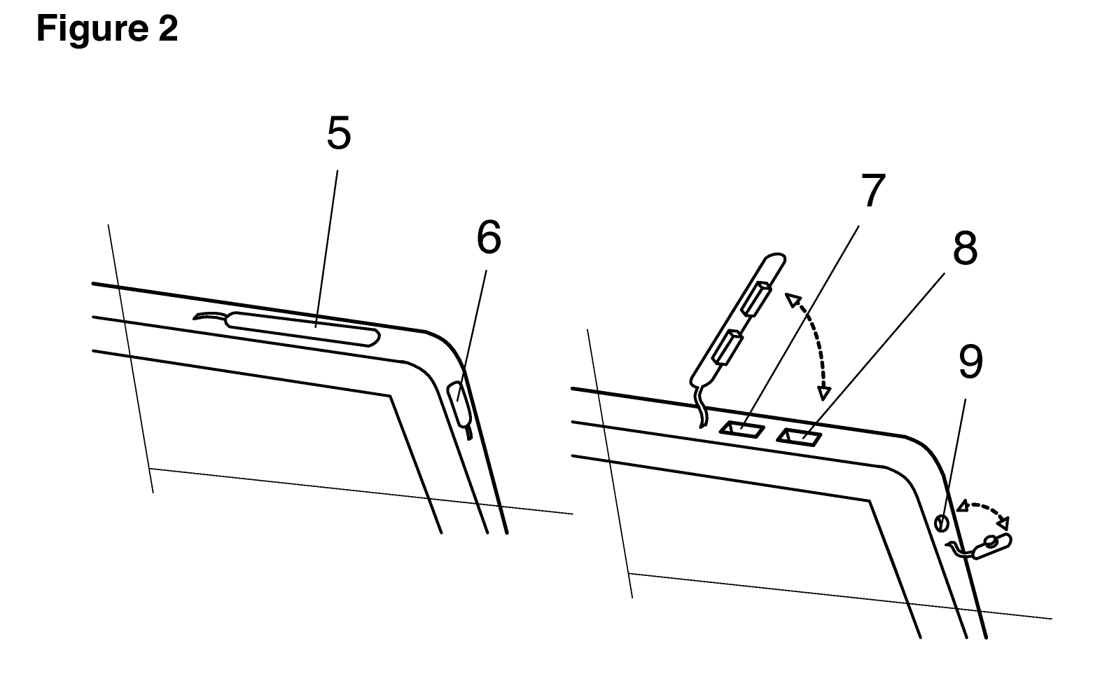

FIG. 2 shows the top and side view of the device. FIG. 2 displays the USB port (7) the fire wire port (8), and the Charging port (9) from a different angle then previously mentioned. FIG. 2 also shows the rubber guard for the USB and Fire wire ports (5) as well as the rubber guard for the Charging port (9). The USB port (7) and fire wire port (8) are used to connect USB and Fire Wire cables which connect to a computer to download or upload information if wireless internet is not available. The rubber guard for USB and Fire Wire ports (5), and charging port (6) fit snugly in the holes of the three ports when fire wire and USB cables are not in use. These three rubber guards (5) (6) are used to protect the device from any damage that may occur in the kitchen or elsewhere.

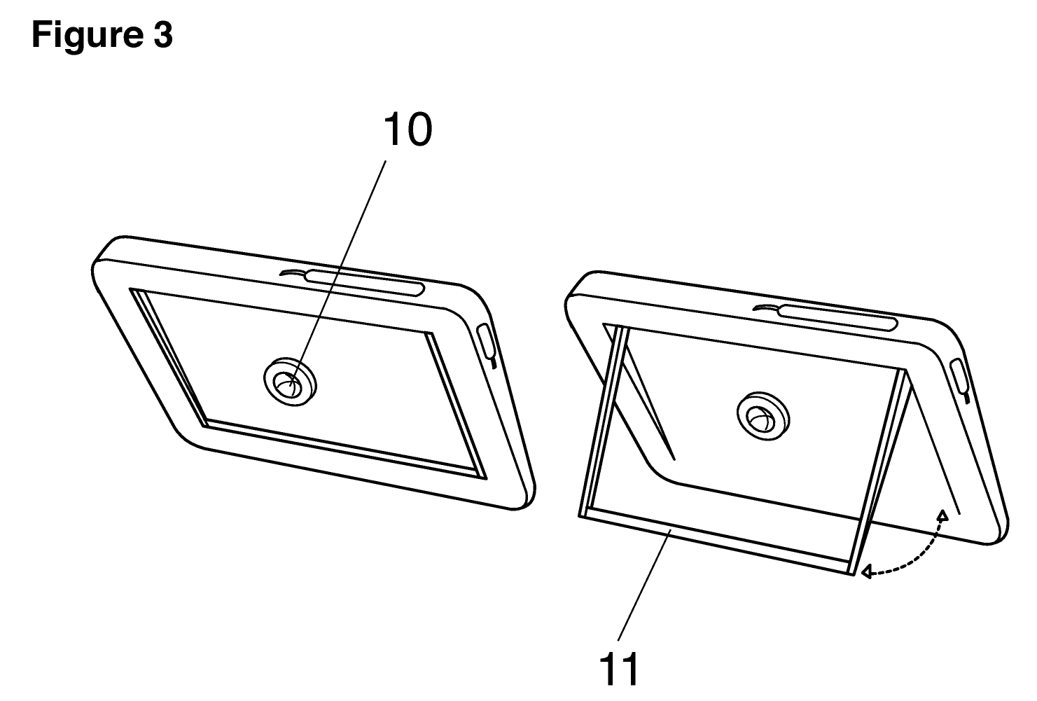

FIG. 3 shows the back side of the device which has a socket joint attachment (10) feature, and a fold out stand. The socket joint feature (10) enables the touchscreen cookbook to be mounted below a cabinet. This ball and socket joint (10) allows the touchscreen cookbook to rotate 360 degrees so it can be viewed easily from anywhere in the kitchen. This feature may take a form other than a ball and socket joint (10). FIG. 3 also shows a fold out stand (13) allowing the touchscreen cookbook to stand up right on a counter. The stand (13) can fold into the back of the touchscreen cookbook when not in use or to take up less storage space. The fold out stand (13) also makes the device less cumbersome when in transport.

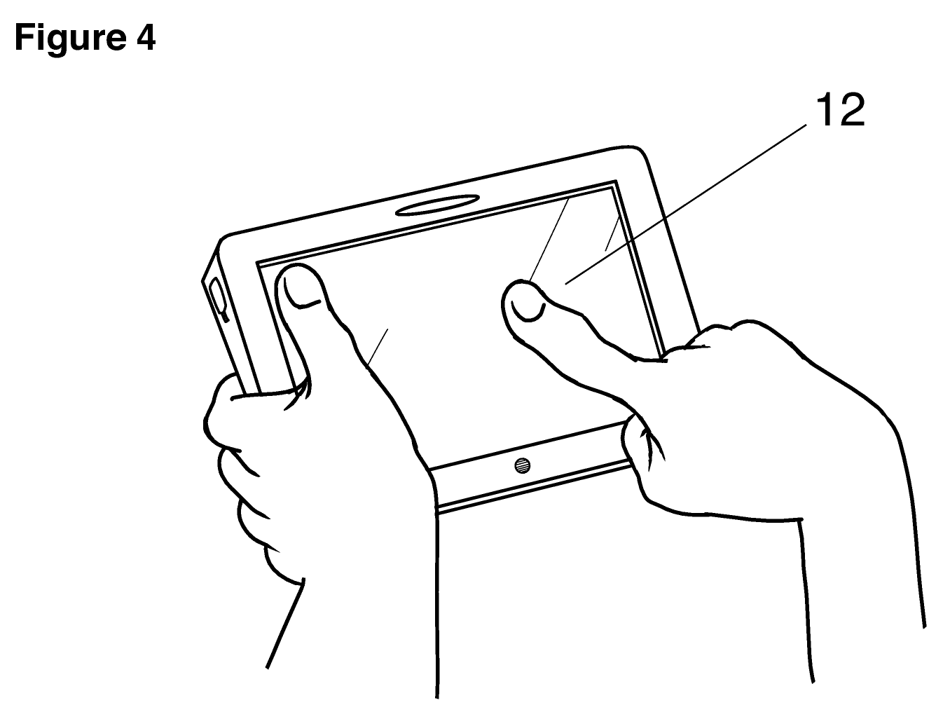

FIG. 4 shows a hand held view (12) of the touchscreen cookbook. This demonstrates approximate scale, and shows ease of use and portability.

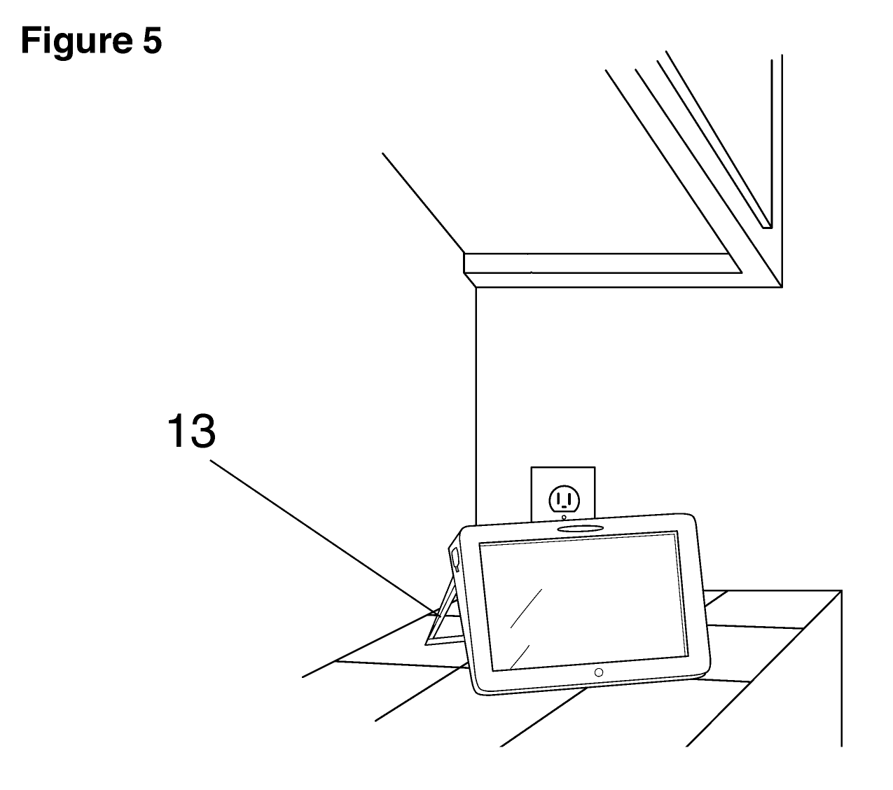

FIG. 5 shows the fold out stand (13) in the counter environment.

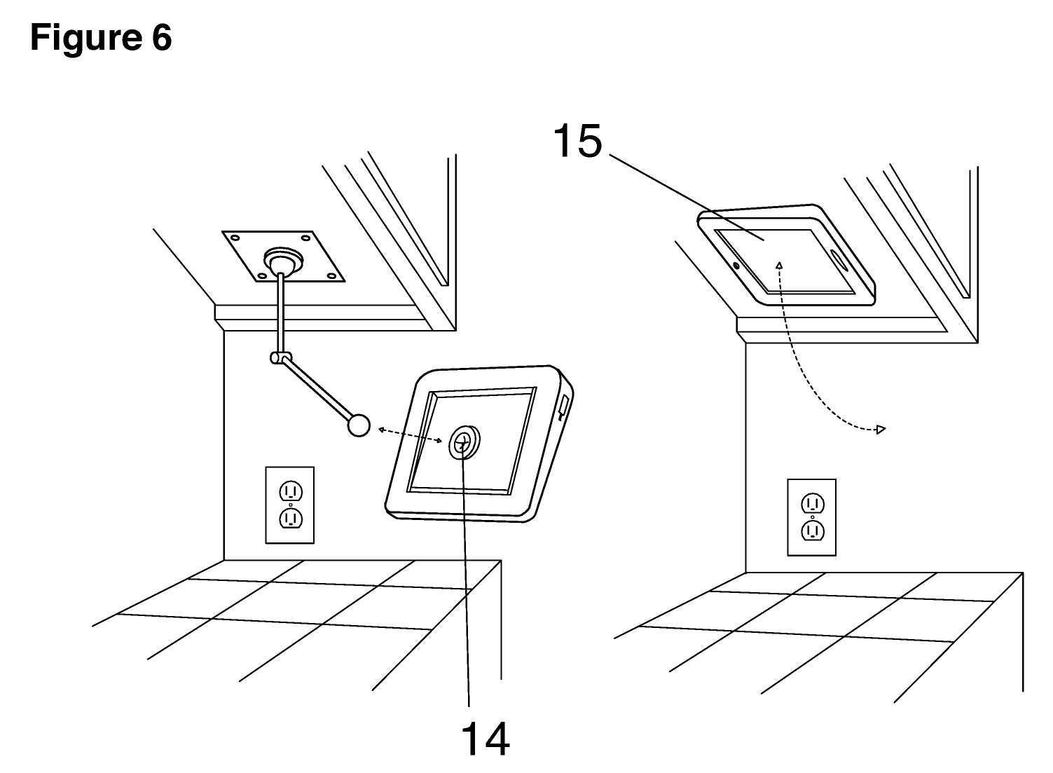

FIG. 6 shows the full ball and socket attachment (10) and jointed rotating connecting arm (14) which connects the cabinet to the touchscreen cookbook. The touchscreen cookbook can be folded underneath the cabinet (15) using the jointed connecting arm (14) when not in use. This arm (15) can bend in any direction and can rotate 360 degrees

The present invention will now be described more fully hereinafter with references to the accompanying drawings, in which preferred embodiments of the invention are shown. This invention may, however, be embodied in many different forms and should not be constructed as limited to the embodiments set forth herein. Rather, these embodiments are provided so that this disclosure will be thorough and complete, and will fully convey the scope of the invention to those skilled in the art. Like numbers refer to like elements throughout, and prime notation is used to indicate similar elements in alternative embodiments.

What is claimed is:

1. An electronic, voice activated touch screen cookbook comprising of a waterproof and self contained touch screen display for navigating through recipe data that is stored internally; system components are designed to store, retrieve, and manage said data within the device and interact with outside systems via wireless technologies.

2. An electronic touch screen cookbook of claim 1 wherein the device is self contained and portable.

3. An electronic touch screen cookbook of claim 1 wherein the device embodies a stand by which to fold out and support the device on any solid surface.

4. An electronic touch screen cookbook of claim 1 wherein the device is waterproof.

5. An electronic touch screen cookbook of claim 1 wherein the mounting hardware allows for 360 degree viewing of the device and embodies overhead and underbody mounting.

6. An electronic touch screen cookbook of claim wherein the device embodies blue tooth, USB and Wi-Fi Internet connections.

7. An electronic touch screen cookbook of claim wherein all information ports are protected with waterproof plugs.

8. An electronic touch screen cookbook of claim wherein the device operates on AC or DC power.
